(19) United States
(12) Patent Application Publication
(10) Pub. No.: US 2015/0044626 A1
(43) Pub. Date: Feb. 12, 2015

(54) METHOD FOR REDUCING ABRASION CAUSED BY BRACES

(71) Applicants: KENNETH PING JIANG, Hollister, CA (US); TERRY CLARK, HOLLISTER, CA (US)

(72) Inventors: KENNETH PING JIANG, Hollister, CA (US); TERRY CLARK, HOLLISTER, CA (US)

(21) Appl. No.: 13/963,795

(22) Filed: Aug. 9, 2013

(51) Int. Cl. A61C 7/12

(52) U.S. Cl. CPC A61C 7/125
USPC 433/24

(57) ABSTRACT

Method for reducing abrasion caused by braces to the interior of a user's mouth are provided in which one of several types of polymeric materials are applied to the braces within the user's mouth and permitted to set, thereby providing an insulative coating of the braces that would otherwise scrape against the interior of the user's mouth and permitting the user to both eat and brush their teeth without substantially impacting the insulative property of the material or dislodging the material from the braces, the material being configured to be removable from the braces with tweezers or the like when the user desires to replace the material periodically. Such materials include compounds from the group consisting of hydrocolloids and elastomers.

### BACKGROUND

Embodiments of the invention herein relate generally to application of protective materials forming an insulative layer between abrasive dental materials and the interior of a patient's mouth. Traditionally, wax or wax-like materials have been applied to braces and other similar dental corrective structures to minimize endothelial trauma of the interior of the mouth from general use (e.g., eating, talking, etc.). However, wax and wax-like materials are flawed in that they are not durable and become more of an inconvenience to the user, minimizing the value of using wax materials as a protective insulating layer. Indeed, after the first use of the wax materials, the user abandons the effort and simply endures the potential discomfort and/or cuts that occur from time to time. Thus, a need has long been felt for an improved method of insulating metal dental structures from the patient's mouth interior to minimize cuts, bruises and general pain of abrasion.

### SUMMARY

Methods are provided for reducing abrasion caused by braces and other dental structures to the interior of a user's mouth, where one such method comprises applying a polymeric material to the braces within the user's mouth and permitting the material to set, thereby providing an insulative coating of the braces that would otherwise scrape against the interior of the user's mouth. This permits the user to both eat and brush their teeth without substantially impacting the insulative property of the material or dislodging the material from the braces. In some embodiments, the material is configured to be removable from the braces with tweezers or the like when the user desires to replace the material periodically. Moreover, the material may comprise one of many different polymeric materials, such as hydrocolloids and elastomers.

### BRIEF DESCRIPTION OF THE FIGURES

The detailed description of some embodiments of the invention will be made below with reference to the accompanying figures, wherein like numerals represent corresponding parts of the figures.

FIG. 1 shows a perspective schematic view of one application of the present invention;

FIG. 2 shows a cross-sectional schematic view on the result of one application of the present invention.

### DETAILED DESCRIPTION OF CERTAIN EMBODIMENTS

By way of background, historically, materials used to adhere crowns and bridges in the dental field have comprised a variety of polymeric materials that may be applied in high-viscosity gelatinous-like and/or paste-like properties that then harden to provide robust and durable bonding. Such polymeric materials are often applied to a patient's teeth and/or dental prosthetics as a combination of discrete materials that are mixed in real time as applied so that the reaction that results in effective adhesive and bonding does not occur prematurely. In that regard, although there are other materials exhibiting generally similar properties, and likely in the future to exist newly-created materials that exhibit generally similar properties, two main types of crown and bridge adhesive bonds include hydrocolloids and elastomers.

Reciting the material properties of such hydrocolloids and elastomers as may be found in generally available textbooks and on reliable websites, a colloid is a state of matter in which individual particles of one substance, are uniformly distributed in a dispersion medium of another substance. When the dispersion medium is water it is termed a hydrocolloid. The colloid is relatively fluid when the solute particles present are dispersed throughout the liquid. This is called a sol. Alternatively, the particles can become attached to each other, forming a loose network which restricts movement of the solute molecules. The colloid becomes viscous and jelly like, and is called a gel. Some colloids have the ability to change reversibly from the sol state to the gel state. A sol can be converted into a gel in one of two ways: reduction in temperature, reversible because sol is formed again on heating (e.g., agar), and chemical reaction that is irreversible (e.g., alginates). A gel may lose (syneresis, which results in shrinkage) or take up (imbibition, which results in expansion) water or other fluids. Hydrocolloids are placed in the mouth in the sol state when it can record sufficient detail, then removed when it has reached the gel state. Hydrocolloid materials especially the alginates, may display a lack of incompatibility with some makes of dental stones. The resultant model may show reduced surface hardness and possibly surface irregularities and roughness.

Elastomers are used where a high degree of accuracy is needed, and are perceived by some to have two main advantages over the hydrocolloids—good tear resistance and dimensional stability. They are mainly hydrophobic rubber-based materials. All of these materials come in different viscosity's ranging from low to high viscosity. The light bodied material maybe used as a wash impression over a medium or heavy-bodied material. There are two ways this can be carried out as described below. In a one-stage impression, light-bodied impression material is placed in a syringe, and placed over the areas where high detail is required (e.g., over a crown preparation). Some is then squirted over the heavy-bodied impression material which has been loaded into an impression tray. The impression is then taken as normal. This technique saves time, but it can be very labor intensive because the two need to mixed at the same time often requiring more than one DSA. IN a two-stage impression, an impression is taken with the heavy-bodied material. This is then removed from the mouth and inspected. The light bodied material is then prepared and again placed in a syringe. This is then squirted over heavy-bodied material and then impression relocated in its original impression. The three main types of elastomers are: polysulphides, silicones (including addition silicones and condensation silicones), and polyethers.

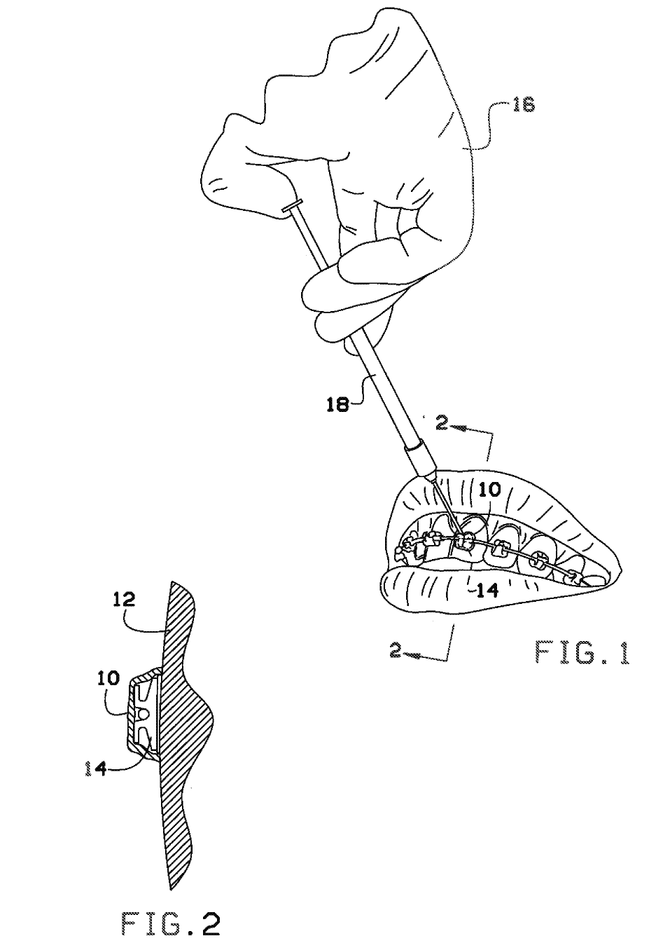

Referring to FIG. 1, for example, one application of the present system comprises a polymeric material 10 applied to a user's teeth 12 and dental structure 14 (e.g., braces) as applied by a clinician 16 using an applicator 18. The material 10 is preferably the type of materials expressed above, including hydrocolloids and elastomers. The choice of material may be determined by the clinician depending upon the environment to be used and the dental structure worn by the patient. It should be noted that the applicator 18 may be one of numerous types of applicators, including those with a single lumen or multiple lumens, where the former is for delivering pre-mixed insulative material and the latter is for applying discrete components that are mixed in real time when applied to the teeth 12 and dental structure 14.

Advantageously, the materials contemplated for application as insulative layers herein at durable and effective, overcoming the prior art problem of wax materials coming off easily and/or providing ineffective protective value. Moreover, while durable, the insulative layers contemplated herein may be removed, in many cases monolithically (i.e., as one piece), by simply grabbing a portion of the hardened material with tweezers or the like. The properties exhibited by the polymeric materials contemplated herein reflect low brittleness, thereby minimizing the layer breaking up into a large number of small pieces.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A method for reducing abrasion caused by braces to the interior of a user's mouth, the method comprising applying a polymeric material to the braces within the user's mouth and permitting the material to set, thereby providing an insulative coating of the braces that would otherwise scrape against the interior of the user's mouth and permitting the user to both eat and brush their teeth without substantially impacting the insulative property of the material or dislodging the material from the braces, the material being configured to be removable from the braces with tweezers or the like when the user desires to replace the material periodically.

2. The method of claim 1, where the material comprises a compound from the group consisting of hydrocolloids and elastomers.
